(19) United States
(12) Patent Application Publication
(10) Pub. No.: US 2010/0118277 A1
(43) Pub. Date: May 13, 2010

(54) DIGITAL DISPLAY DEVICE

(75) Inventor: JEN-TSORNG CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/491,239

(22) Filed: Jun. 25, 2009

(30) Foreign Application Priority Data
Nov. 7, 2008 (CN) 200810305421.X

(51) Int. Cl. G03B 21/28; G02B 26/00

(52) U.S. Cl. 353/36; 359/221.2

(57) ABSTRACT

An exemplary digital display device includes a light source, a converging member, a micro-electrical-mechanical system (MEMS) chip, and a projection member. The converging member is for converging the light emitted from the light source onto the MEMS chip. The MEMS chip is for selectively reflecting light transmitted from the converging member to form an alphanumeric character to the projection member. The projection member is for projecting the alphanumeric character onto a projection screen.

### BACKGROUND

1. Technical Field

The present disclosure relates to a digital display device and, particularly, to a micro-electrical-mechanical system (MEMS) digital display device.

2. Description of Related Art

Recently, seven-segment displays are widely used in digital clocks, electronic meters, and other electronic devices for displaying alphanumeric information.

In a typical digital display device, light emitting diode (LED) based seven-segment displays are commonly used. However, each LED requires packaging before application, thus it makes the digital display device large and heavy, which is not suitable for the miniaturized handheld devices for displaying alphanumeric information.

Therefore, a new digital display device is desired to overcome the above mentioned problems.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, perspective view of a digital display device in accordance with a first embodiment of the present invention.

FIG. 2 is a schematic, top plan view of a reflective member group of FIG. 1.

FIG. 3 is a schematic, perspective view of a reflective member of FIG. 2.

FIG. 4 is a schematic, perspective view of a moving mirror in the reflective member of FIG. 3.

FIG. 5 is a schematic, top plan view of a reflective member group in accordance with a second embodiment of the present invention.

FIG. 6 is a schematic, top plan view of a reflective member group in accordance with a third embodiment of the present invention.

### DETAILED DESCRIPTION

Embodiments will now be described in detail below with reference to the drawings.

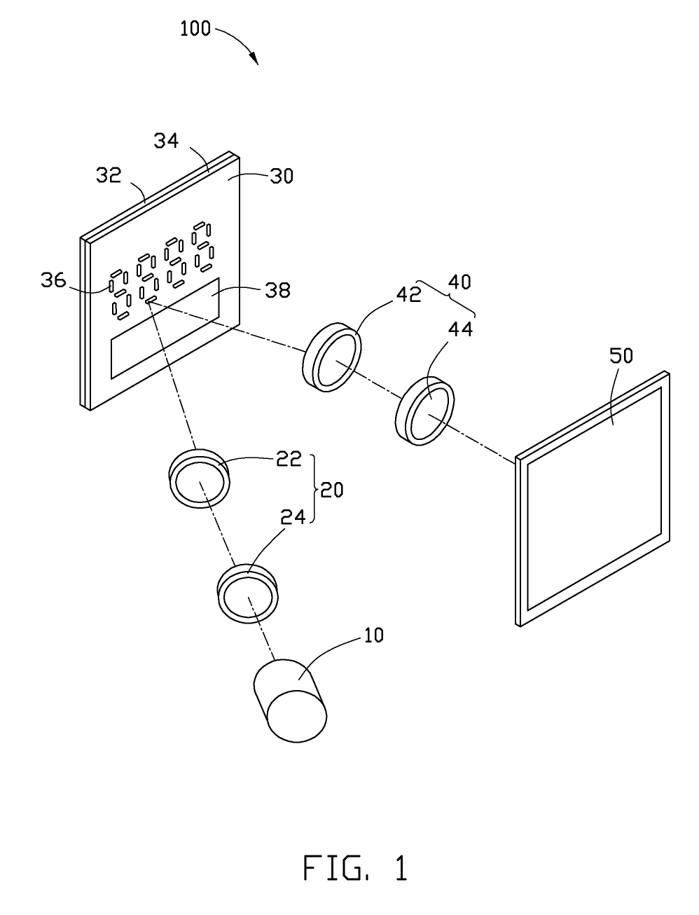

Referring to FIG. 1, a digital display device 100 includes a light source 10, a converging member 20, a MEMS chip 30, and a projection member 40.

The light source 10 can be one of a laser source and a light emitting diode (LED) source.

The converging member 20 includes two converging lenses 22, 24 for converging light emitted from the light source 10 onto the MEMS chip 30.

The MEMS chip 30 reflects the light transmitted from the converging member 20 to form an alphanumeric character. The alphanumeric character can be ten Arabic numerals, Latin letters, Cyrillic, Greek alphabets or mathematical symbols.

The projection member 40 includes two projection lenses 42, 44. The projection member 40 projects the alphanumeric character onto a projection screen 50.

The MEMS chip 30 is fabricated using MEMS and complementary metal oxide semiconductor (CMOS) techniques. The MEMS chip 30 includes a substrate 32, a light absorption layer 34 formed on the substrate 32, and a plurality of reflective member groups 36 formed on the light absorption layer 34, and a controller 38. The substrate 32 can be a silicon substrate, for example. In one embodiment, the light absorption layer 34 can be made of chromium. Because the light absorption layer 34 not covered by the reflective member groups 36 can absorb light, the projection screen 50 appears dark corresponding to the light absorption layer 34 not covered by the reflective member groups 36. Each reflective member group 36 consists of a plurality of reflective members arranged in a predetermined pattern being configured for displaying one of the alphanumeric characters. In the present embodiment, four reflective member groups 36 are adopted. It can be understood that the number of the reflective member groups 36 depends on the application and requirements. The controller 38 can be a pulse-width modulation (PWM) controller.

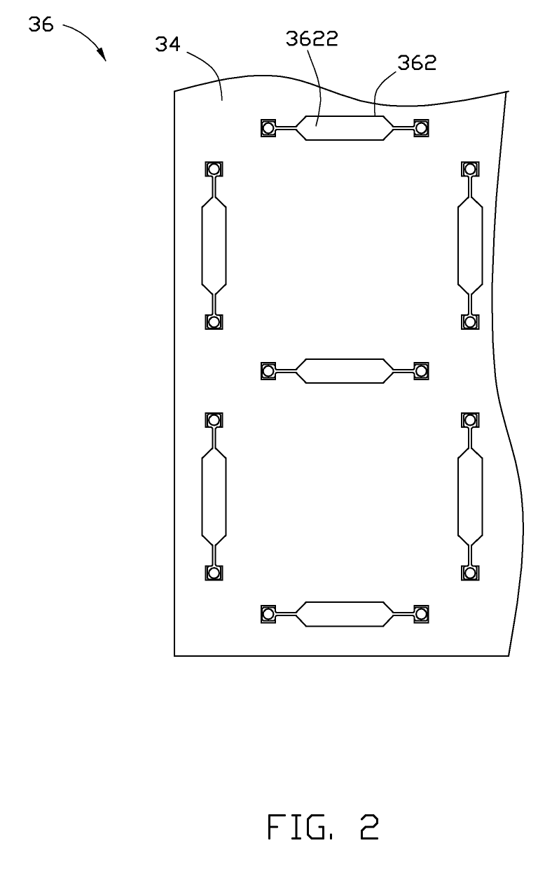

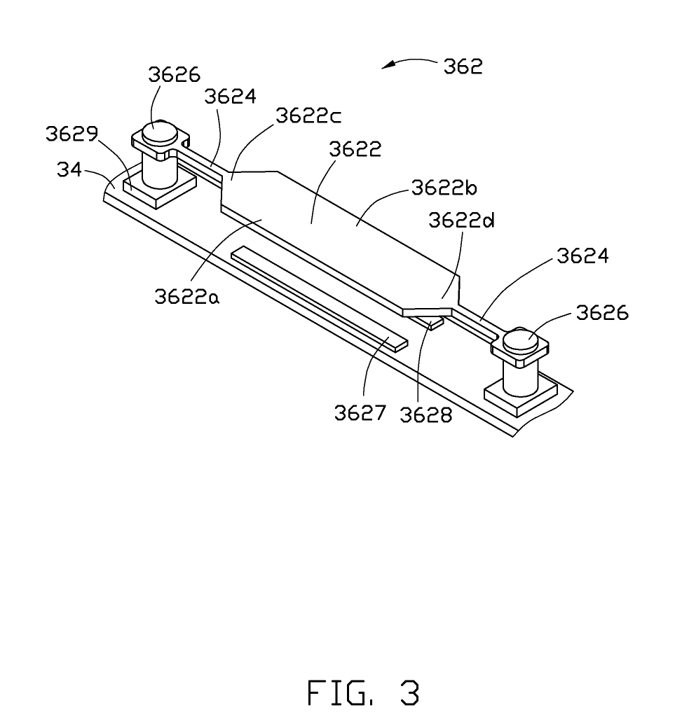

Referring to FIGS. 2-3, each reflective member group 36 consists of seven reflective members 362 arranged in a seven-segment pattern. Each reflective member 362 includes a mirror 3622, two torsion beams 3624, two support posts 3626, a first electrode 3627, a second electrode 3628, and two insulation pads 3629. In the seven-segment pattern, seven mirrors 3622 are arranged as a rectangle of two vertical mirrors 3622 on each side with one horizontal mirror 3622 on the top and bottom, respectively. Additionally, the seventh mirror 3622 bisects the rectangle horizontally.

The mirror 3622 suspends above the light absorption layer 34. The mirror 3622 is strip shaped. The mirror 3622 includes a first side edge 3622a, a second side edge 3622b, and two opposite ends 3622c, 3622d. The mirror 3622 is made of polysilicon. The mirror 3622 can further have a metal layer (not shown), such as gold or copper layer formed thereon to enhance the reflective effect thereof.

The two torsion beams 3624 extend from opposite ends 3622c, 3622d of the mirror 3622 respectively. The two torsion beams 3624 are fixed to the mirror 3622 by an adhesive or solder. It can be understood that the torsion beams 3624 can also be integrally formed with the mirror 3622. Each of the torsion beams 3624 is made of elastic polysilicon and is deformable.

The two support posts 3626 connect the two torsion beams 3624, respectively, in order to support the two torsion beams 3624 and the mirror 3622.

Each of the insulation pads 3629 is disposed between each of the support posts 3626 and the light absorption layer 34. Each of the insulation pads 3629 is made of silicon nitride or silicon dioxide.

The first electrodes 3627 and the second electrodes 3628 are disposed on the light absorption layer 34 below the first and the second side edges 3622a, 3622b of the mirror 3622, respectively.

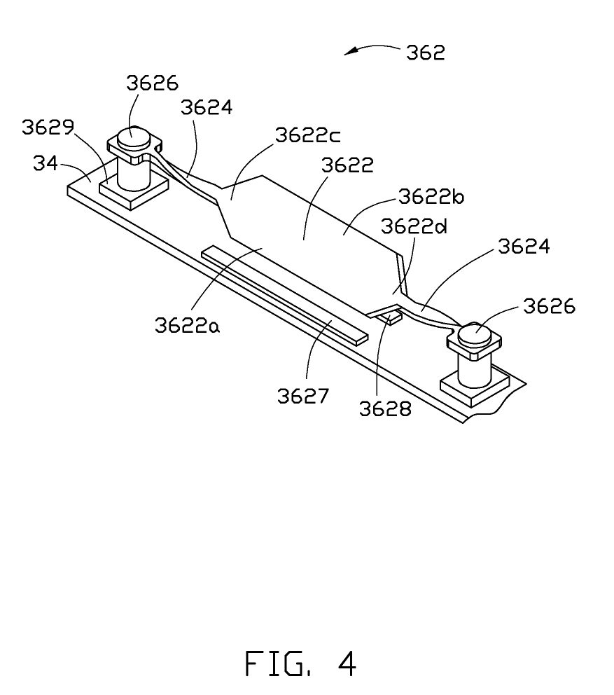

Referring to FIG. 4, when a voltage is applied to the first electrode 3627 and the mirror 3622, the mirror 3622 moves relative to the light absorption layer 34 with the first side edge 3622a towards the first electrode 3627 due to an electrostatic attraction between the first electrode 3627 and the mirror 3622. The mirror 3622 can return to its original position when the voltage is withdrawn. Likewise, when a voltage is applied to the second electrode 3628, the mirror 3622 moves relative to the light absorption layer 34 with the second side edge 3622b towards the second electrode 3628. The controller 38 of the MEMS chip 30 can control the voltage applied to the first electrode 3627 or the second electrode 3628. In the present embodiment, the reflective member 362 is in the first position when the mirror 3622 moves towards the first electrode 3627, while the reflective member 362 is in the second position when the mirror 3622 moves towards the second electrode 3628. When the mirror 3622 is in the first position, light from the converging member 20 is reflected onto the projection screen 50. When the mirror 3622 is in the second position, light is directed elsewhere, usually onto a heatsink (not shown) for example. The mirrors 3622 in the first positions cooperatively form an alphanumeric character. It can be understood that the reflective member 362 can be in the first position when the mirror 3622 moves towards the second electrode 3628, which can be controlled by adjusting the optical path. Therefore, to reposition each mirror 3622 of each reflective member 36, light incident upon the MEMS chip 30 can be selectively reflected into the projection member 40, thus resulting in the corresponding alphanumeric character being displayed on the projection screen 50. Each of the moving angles between the first electrode 3627 and second electrode 3628 and the mirror 3622 are the same. The moving angles can be a predetermined value, for example 10-12 degrees.

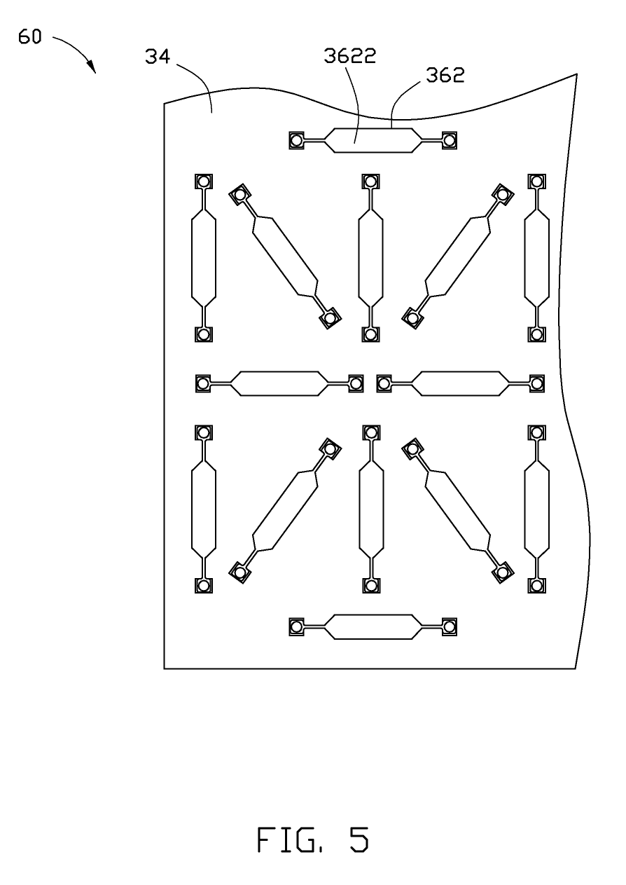

Referring to FIG. 5, a reflective member group 60 according to a second embodiment is shown. The reflective member group 60 consists of fourteen reflective members 362 arranged in a fourteen-segment pattern. It is an extension of the above described reflective member group 36 in the first embodiment, but adding four diagonal mirrors 3622 and two vertical mirrors 3622 and with two middle horizontal mirrors 3622 other than one.

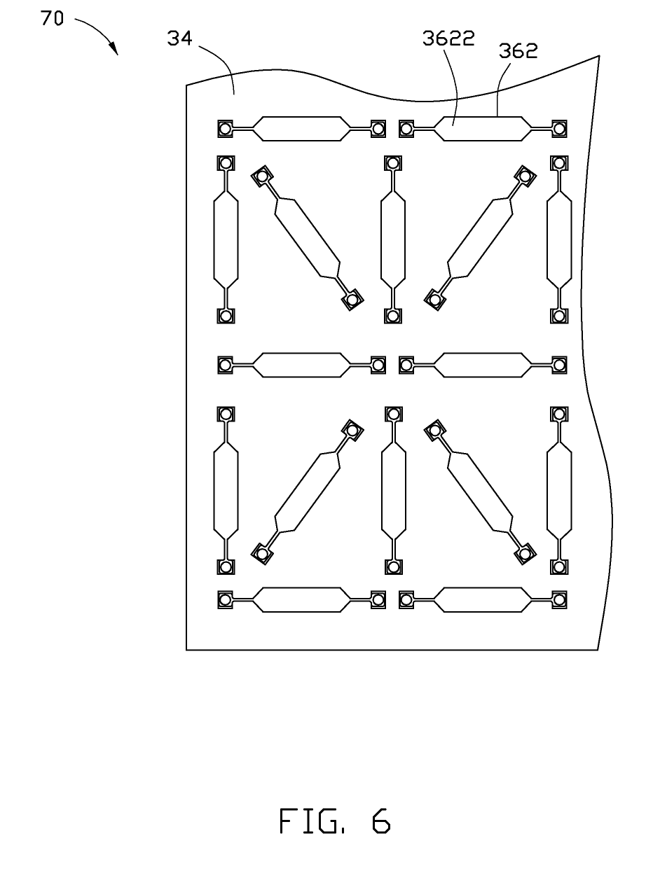

Referring to FIG. 6, a reflective member group 70 according to a third embodiment is shown. The reflective member group 70 consists of sixteen reflective members 362 arranged in a sixteen-segment pattern. It is an extension of the above described reflective member group 60 in the second embodiment, but with two horizontal mirrors 3622 on the top and bottom, respectively.

It can be understood that the layout and the number of the mirrors in each reflective member group are not limited to the above described embodiments, which can be set according to the alphanumeric character being displayed.

The digital display device 100 is fabricated using MEMS and CMOS techniques, thus the digital display device 100 is compact, light-weight, low cost, and very suitable for the miniaturized handheld device, for example, mp3, cell phone, for displaying the alphanumeric information.

While certain embodiments have been described and exemplified above, various other embodiments from the foregoing disclosure will be apparent to those skilled in the art. The present invention is not limited to the particular embodiments described and exemplified but is capable of considerable variation and modification without departure from the scope and spirit of the appended claims.

1. A digital display device for projecting an alphanumeric character onto a projection screen comprising:
a light source;
a converging member configured for converging light emitted from the light source;
a MEMS chip configured for being illuminated by the light source and reflecting the light, the MEMS chip comprising a substrate, a light absorption layer formed on the substrate, a plurality of reflective member groups disposed on the light absorption layer, and a controller, each reflective member group consisting of a plurality of reflective members arranged in a predetermined pattern selected from the group consisting of seven-segment pattern, fourteen-segment pattern, and sixteen-segment pattern, each reflective member comprising a mirror suspending above the light absorption layer, the mirror being movable relative to the light absorption layer between a first position where the light is reflected by the mirror onto the projection screen, and a second position where the light is reflected and directed by the mirror to bypass the projection screen, the controller configured for controlling the movement of each of the mirrors, whereby the mirrors in the first positions cooperatively form an alphanumeric character; and
a projection member configured for projecting the alphanumeric character onto the projection screen.

2. The digital display device of claim 1, wherein the seven-segment pattern is that seven mirrors are arranged as a rectangle of two vertical mirrors on each side with one horizontal mirror on the top and bottom, and the seventh mirror bisects the rectangle horizontally.

3. The digital display device of claim 1, wherein the fourteen-segment pattern is that fourteen mirrors are arranged as a rectangle of two vertical mirrors on each side, one horizontal mirror on the top and bottom, two middle horizontal mirrors, four diagonal mirrors and two middle vertical mirrors.

4. The digital display device of claim 1, wherein the sixteen-segment pattern is that sixteen mirrors are arranged as a rectangle of two vertical mirrors on each side, two horizontal mirrors on the top and bottom, two middle horizontal mirrors, four diagonal mirrors and two middle vertical mirrors.

5. The digital display device of claim 1, wherein the alphanumeric character is selected from the group consisting of Arabic numerals, Latin letters, Cyrillic, Greek alphabets and mathematical symbols.

6. The digital display device of claim 1, wherein each reflective member comprises two flexible torsion beams and two support posts mounted on the substrate, and the torsion beams extend from opposite ends of the mirror.

7. The digital display device of claim 6, wherein each of the torsion beams is made of polysilicon.

8. The digital display device of claim 6, wherein the two torsion beams are fixed to the mirror by an adhesive or solder.

9. The digital display device of claim 1, wherein each reflective member further comprises a first electrode and a second electrode, the first electrode and the second electrode configured for creating an electrostatic attraction between the first and second electrodes and the mirror so as to move the mirror between the first position and the second position.

10. The digital display device of claim 1, wherein the mirror is made of polysilicon.

11. The digital display device of claim 1, wherein the mirror is strip shaped.

12. The digital display device of claim 1, wherein the MEMS chip further comprises an insulation pad disposed between each of the support posts and the light absorption layer.

13. The digital display device of claim 12, wherein the material of each of the insulation pads is selected from the group consisting of silicon nitride and silicon dioxide.

14. A digital display device for projecting an alphanumeric character onto a projection screen comprising:
a light source;
a converging member configured for converging light emitted from the light source;
a MEMS chip configured for being illuminated by the light source and reflecting the light, the MEMS chip comprising a substrate, a light absorption layer formed on the substrate, a plurality of reflective member groups disposed on the light absorption layer, and a controller, each reflective member group comprising a plurality of reflective members arranged in a predetermined pattern selected from the group consisting of seven-segment pattern, fourteen-segment pattern, and sixteen-segment pattern, each reflective member comprising a mirror suspending above the light absorption layer, two flexible torsion beams, two support posts, a first electrode and a second electrode, the two torsion beams extending from opposite ends of the mirror respectively, the first electrode and the second electrode configured for creating an electrostatic attraction between the first and second electrodes and the mirror so as to move the mirror between a first position where the light is reflected by the mirror onto the projection screen, and a second position where the light is reflected and directed by the mirror to bypass the projection screen, whereby the mirrors in the first positions cooperatively form an alphanumeric character; and
a projection member configured for projecting the alphanumeric character onto the projection screen.

15. The digital display device of claim 14, wherein the alphanumeric character is selected from the group consisting of Arabic numerals, Latin letters, Cyrillic, Greek alphabets and mathematical symbols.

16. The digital display device of claim 14, wherein each of the torsion beams is made of polysilicon.

17. The digital display device of claim 14, wherein the mirror is made of polysilicon.

18. The digital display device of claim 14, wherein each mirror is strip shaped.

19. The digital display device of claim 14, wherein the MEMS chip further comprises an insulation pad disposed between each of the support posts and the light absorption layer.

20. The digital display device of claim 19, wherein the material of each of the insulation pads is selected from the group consisting of silicon nitride and silicon dioxide.
